(19) United States
(12) Patent Application Publication
(10) Pub. No.: US 2021/0164584 A1
(43) Pub. Date: Jun. 3, 2021

(54) Bistable anti-stall valve system

(71) Applicant: Miro Capitanio, Vicenza (IT)

(72) Inventor: Miro Capitanio, Vicenza (IT)

(21) Appl. No.: 15/733,476

(22) PCT Filed: Mar. 26, 2019
(86) PCT No.: PCT/IB2019/052423

§ 371 Date: Aug. 5, 2020

(30) Foreign Application Priority Data
Mar. 30, 2018 (IT) 102018000004121

(51) Int. Cl. F16K 31/122; F16K 11/065; F16K 31/56; F16K 31/06

(52) U.S. Cl. CPC F16K 31/122; F16K 31/0624; F16K 31/56; F16K 11/0655

(57) ABSTRACT

A bistable valve system includes a valve body, a plug, a pneumatic or mechanical driving system acting on the plug, and an anti-stall system also acting on the plug to avoid an operative block. The valve body has an inlet for a working fluid, first and second outlets for the working fluid, and a working chamber. The plug is slidably inserted into the working chamber to move between a first and a second stable working position so as to alternatingly and selectively place the inlet and the first or the second outlet in fluid communication. The anti-stall system includes a first permanent magnet coupled with the plug to integrally slide therewith and a second permanent magnet arranged in the working chamber facing the first permanent magnet. The first and second permanent magnets have a opposite polarities to generate forces that are repulsive with respect to each other.

### FIELD OF THE INVENTION

The present invention applies to the technical field of valve systems, and in particular it regards a bistable anti-stall valve system that can be driven mechanically or pneumatically.

### STATE OF THE ART

It is known that controlling devices characterised by alternating linear motions, for example pumps, oscillators, compressed air reciprocating motors, pistons, pneumatic hammers, vibrators, boosters, requires bistable valve systems suitable to alternatingly and selectively convey the working fluid into the two half-chambers of such devices.

Two main systems for driving such valve systems, pneumatic or mechanical, both acting directly on the movable parts of the valves are known.

A known disadvantage of such types of valve systems lies in the so-called stall or “dead centre” problem, i.e. an operative stall situation in which the valve system blocks, with ensuing stall of the device to which it is connected and thus requires manual intervention.

Permanent magnets arranged along the sliding axis of the movable sealing members, as disclosed in the U.S. Pat. No. 5,222,876, were used to overcome such drawback.

However, such known problem revealed to be inefficient towards avoiding the aforementioned problem related to stalling or “dead centre”.

### SUMMARY OF THE INVENTION

An object of the present invention is to at least partly overcoming the drawbacks illustrated above, by providing a valve system that is highly efficient and functional.

A further object of the invention is to provide a particularly effective valve system, that allows overcoming the drawback related to stalling or so-called “dead centre”.

A further object of the invention is to provide valve system has a minimum number of components.

A further object of the invention is to provide a valve system that is small in size.

A further object of the invention is also to provide a valve system that is easy to manufacture and maintain.

These and other objects that will be more apparent hereinafter, are attained by a valve system according to what is described, illustrated and/or claimed herein.

Advantageous embodiments of the invention are defined in the dependent claims.

### BRIEF DESCRIPTION OF THE DRAWINGS

Further characteristics and advantages of the invention will be more apparent in light of the detailed description of a preferred but non-exclusive embodiment of valve system 1, illustrated by way of non-limiting example with reference to the attached drawings, wherein:

FIG. 1A is an axonometric view of a first embodiment of the valve system 1;

FIGS. 1B, 1C, 1D are respectively top, lateral and front views of the embodiment of the valve system 1;

FIG. 2A is a sectional view along a section plane π2-π2 taken in FIG. 1B when the slider 21 is in the first stable working position;

FIG. 2B is a sectional view along a section plane π-π taken in FIG. 2A when the slider 21 is in the first or second stable working position;

FIG. 2C is an enlarged detail of FIG. 2B;

FIG. 2D is a sectional view along a section plane π2-π2 taken in FIG. 1B when the slider 21 is in the second stable working position;

FIG. 2E is an enlarged detail of FIG. 2D;

FIG. 3A is a sectional view along a section plane π2-π2 taken in FIG. 1B when the slider 21 is in the position defining the stall or the so-called ‘dead centre’;

FIG. 3B is a sectional view along a section plane π-π taken in FIG. 2A when the slider 21 is in the position defining the stall or the so-called ‘dead centre’;

FIG. 3C is an enlarged detail of FIG. 3B;

FIG. 4 is a sectional view along a section plane II-II taken in FIG. 3B;

FIG. 5 is a sectional view along a section plane III-III taken in FIG. 1C, in which the pins 37, 37′ were removed for the sake of simplicity;

FIG. 6 is an axial sectional view of a first embodiment of a double membrane pump P1 which comprises a second embodiment of the valve system 1;

FIGS. 7A and 7B are enlarged views of some details of the embodiment of the valve system 1 of FIG. 6 in which the slider element 21′ is respectively in the first and in the second stable working position;

FIGS. 8A and 8B are axonometric views of some details of the slider element 21′—actuator element 36 assembly of the embodiment of the valve system 1 of FIG. 6 in which the plug 21′ is respectively in the first and in the second working position, with in FIGS. 9A and 9B respective axial sectional views;

FIGS. 10A and 10B are schematic views of the slider element 21′—actuator element 36 assembly of the first embodiment of the valve system 1 of FIG. 6 respectively in the first and in the second stable working position;

FIG. 11 is a schematic view of the slider element 21′—actuator element 36 assembly of the embodiment of the valve system 1 of FIG. 6 in the stall or so-called “dead centre” position;

FIG. 12 is an axonometric view of the slider element 21′ of the embodiment of the valve system 1 of FIG. 6;

FIG. 13 is an axonometric view of the actuator element 36 of the embodiment of the valve system 1 of FIG. 6;

FIG. 14 is an axial sectional view of a further embodiment of a double membrane pump P2 which includes a third embodiment of the valve system 1;

FIGS. 15A and 15B are enlarged views of some details of the embodiment of the valve system 1 of FIG. 14 in which the slider element 21′ is respectively in the first and in the second stable working position;

FIG. 16 is an axonometric view of some details of the embodiment of the valve system 1 of FIG. 14;

FIG. 17 is an axonometric view of some details of the fixed air distributor 2′ of the embodiment of the valve system 1 of FIG. 14;

FIG. 18 is an axonometric view of the slider element 21′ of the embodiment of the valve system 1 of FIG. 14;

FIG. 19 is an axonometric view of the actuator element 36 of the embodiment of the valve system 1 of FIG. 14;

FIGS. 20A and 20B are axial sectional views of an embodiment of a double piston pump P3 which includes a further embodiment of the valve system 1, in which the slider element 21′ is respectively in the first and in the second stable working position.

### DETAILED DESCRIPTION OF SOME PREFERRED EMBODIMENTS

With reference to the aforementioned figures, herein described are some possible embodiments of the valve system 1.

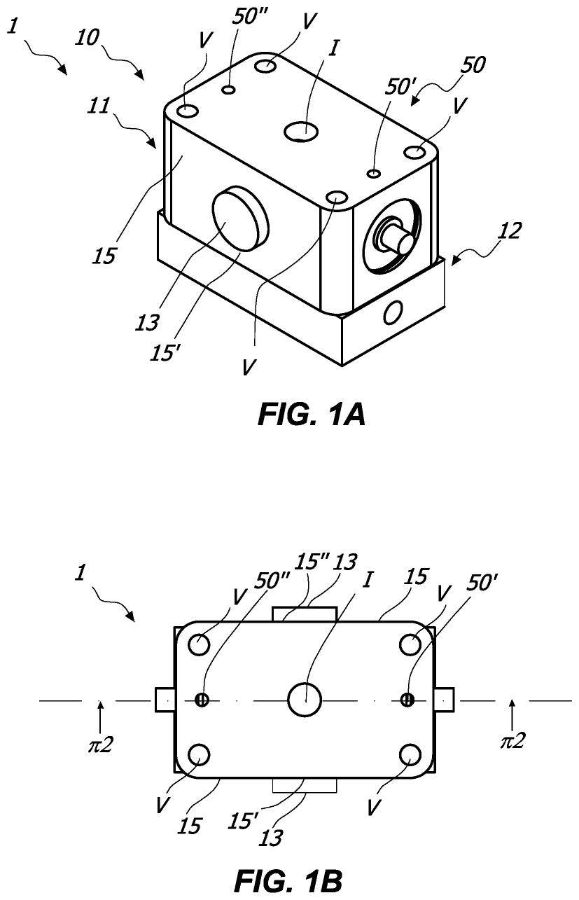

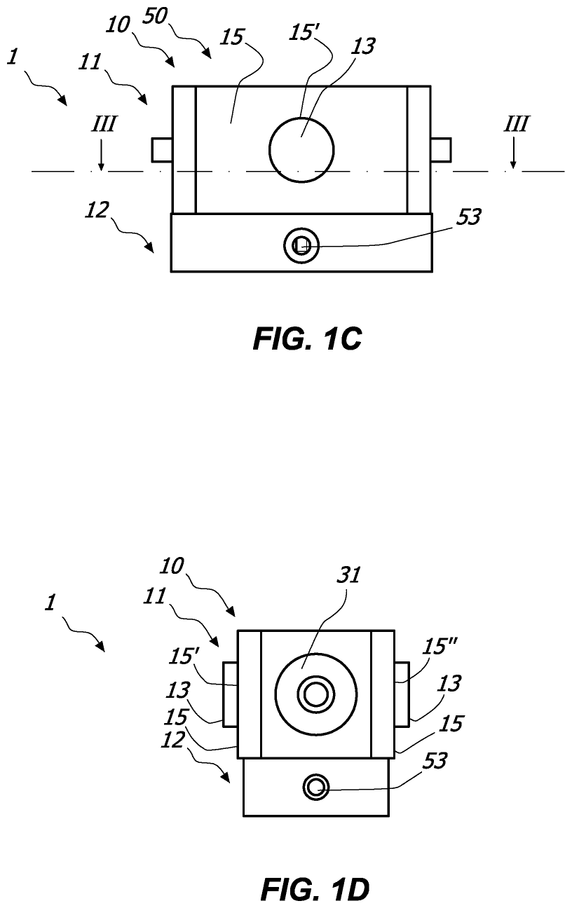

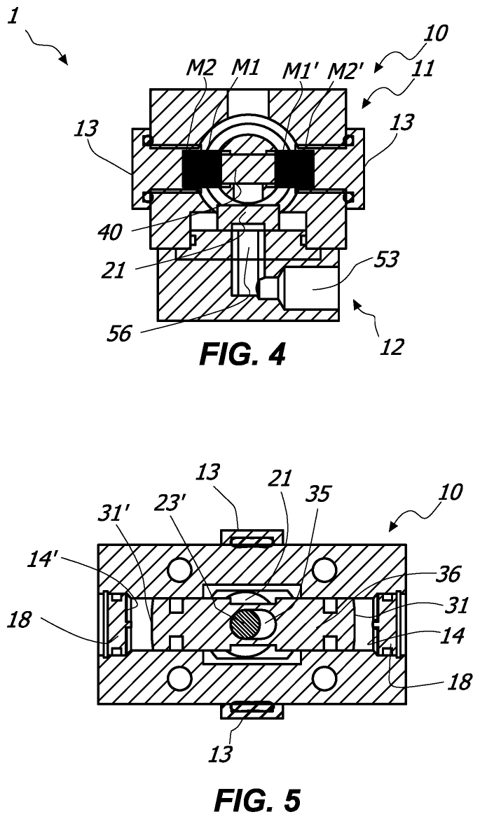

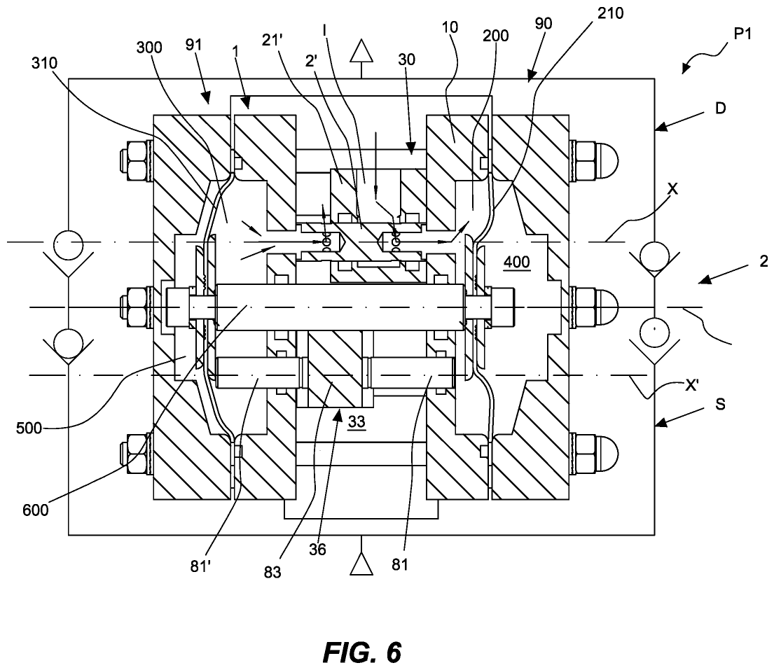

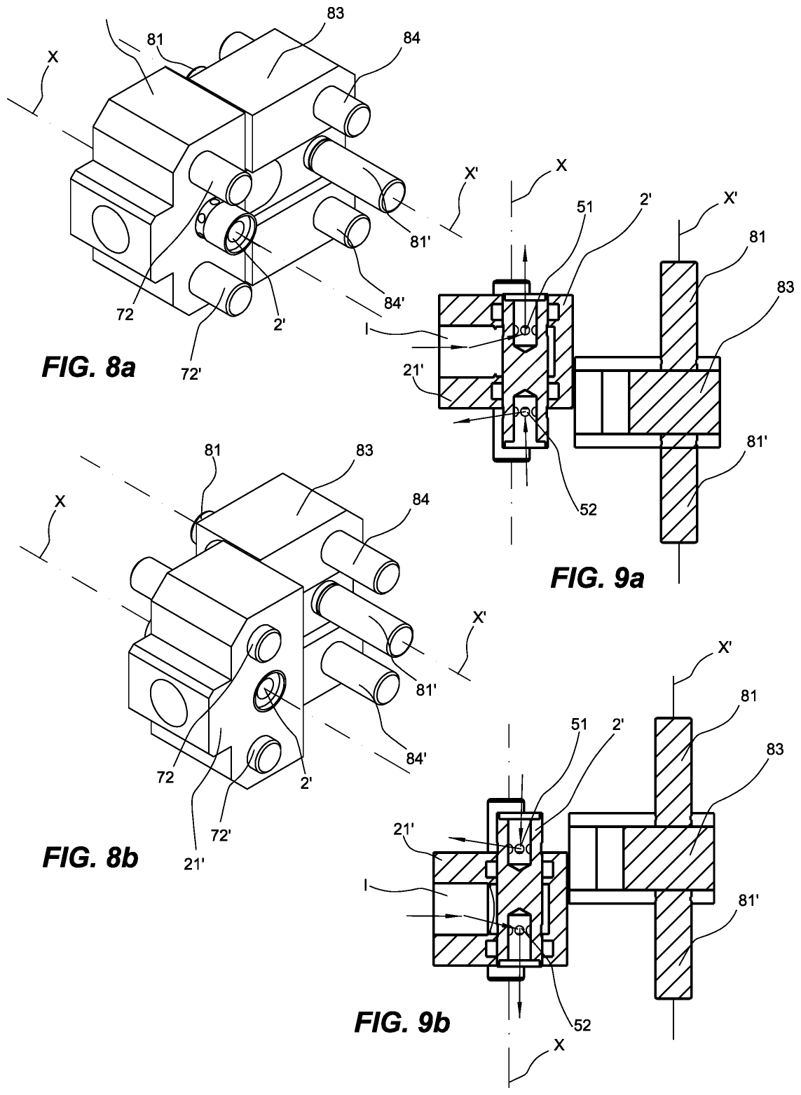

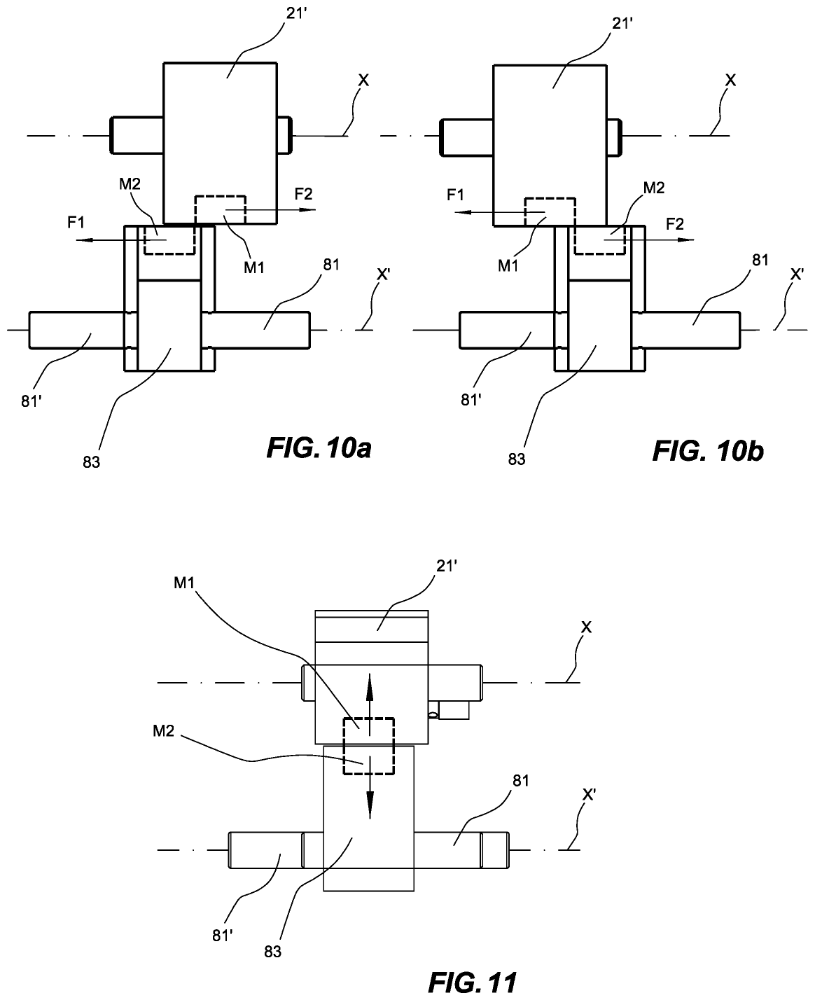

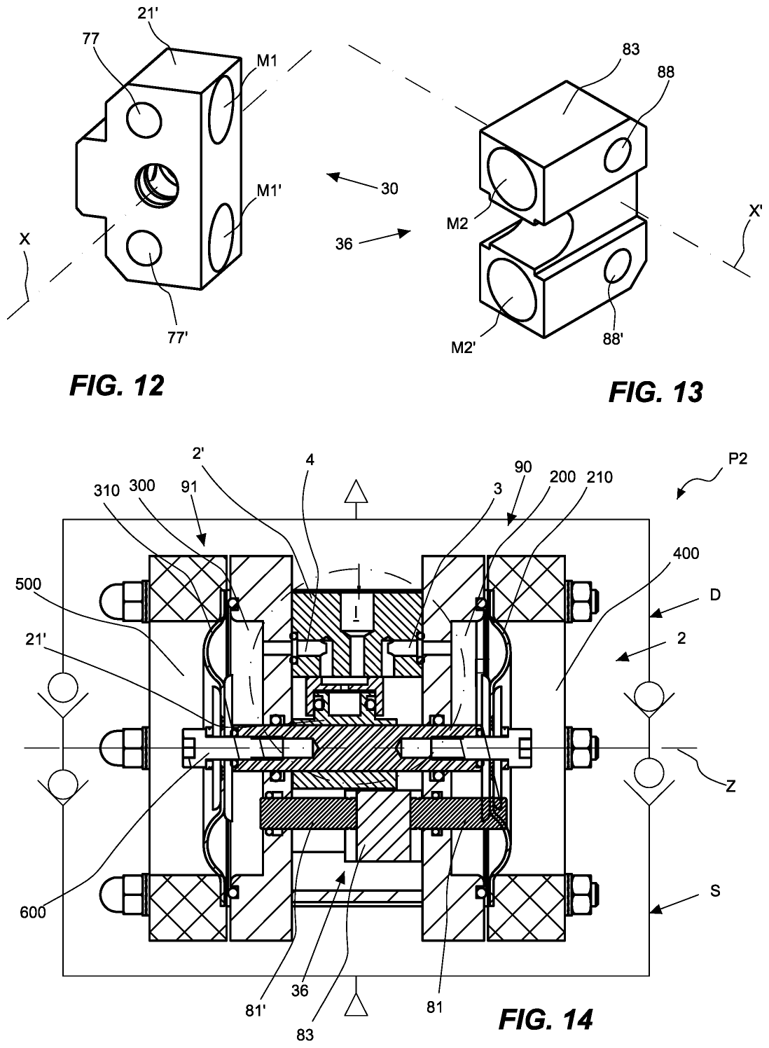

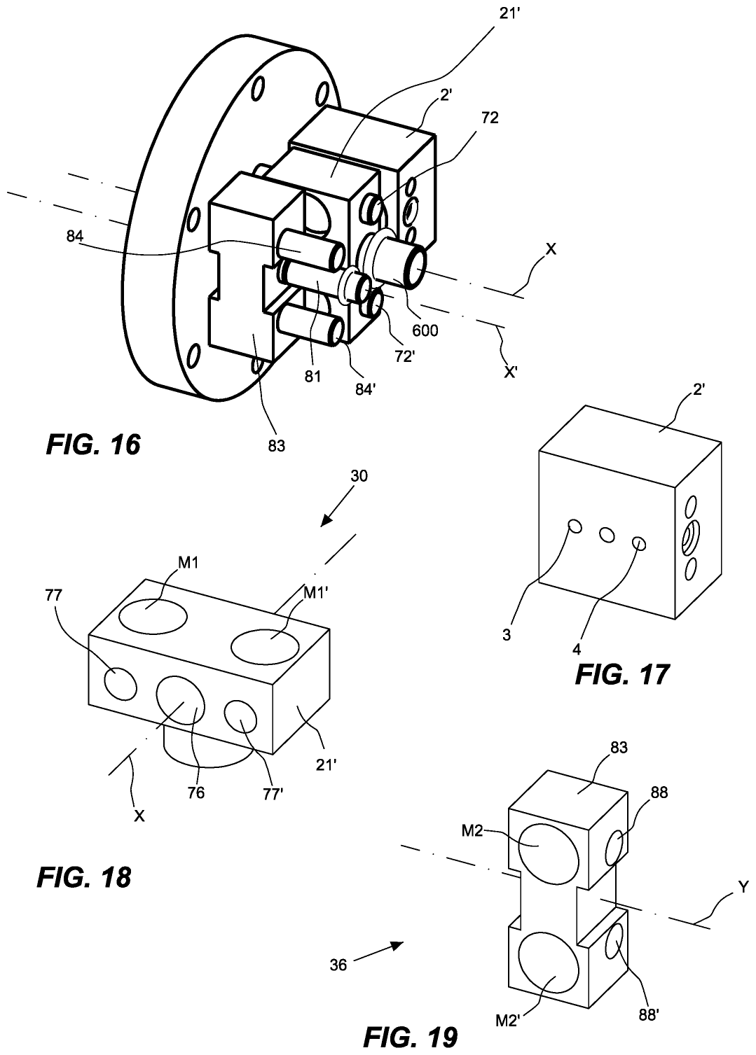

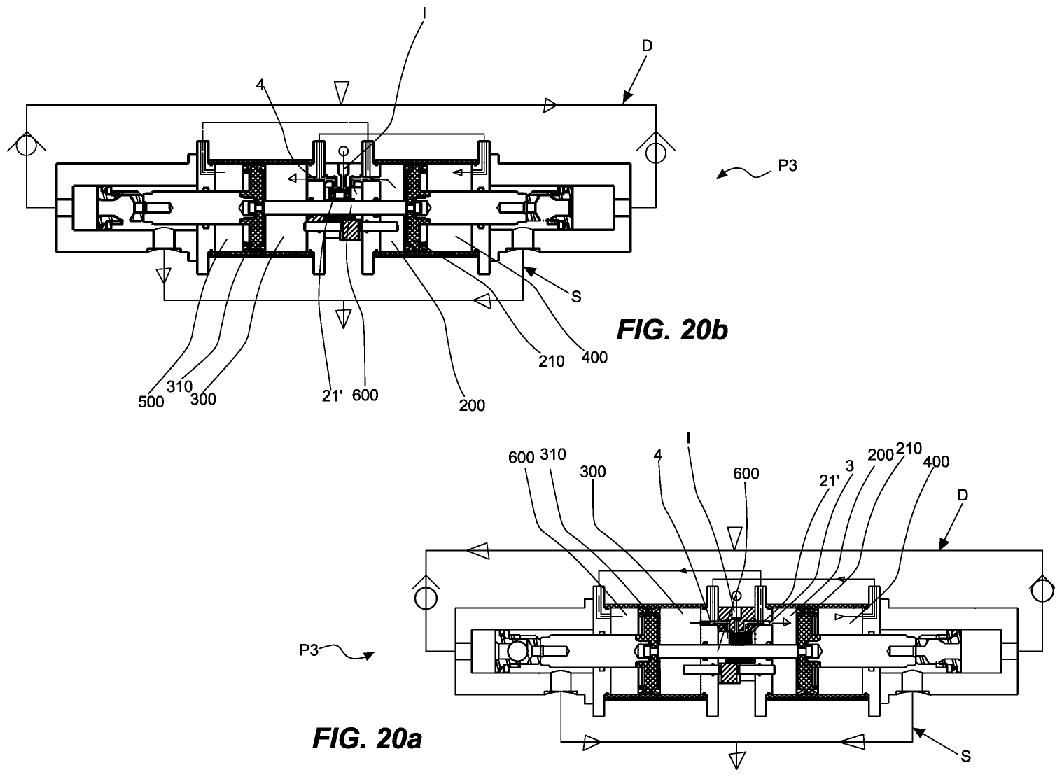

More in particular, FIGS. 1A to 5 illustrate a first embodiment of the valve system 1, FIGS. 6 to 13 illustrate a second embodiment of the valve system 1 implemented in a double membrane pump P1, FIGS. 14 to 19 illustrate a third embodiment of the valve system 1 illustrated in a double membrane pump P2 and FIGS. 20A and 20B illustrate a fourth embodiment of the valve system 1 illustrated in a double piston pump P3.

The present invention has various parts that are equal or however equal to each other. Unless otherwise specified, such parts that are equal or similar will be indicated with a single reference number, it being intended that the indicated characteristics are common to all equal or similar parts.

Generally, the valve system 1 may be made using nonmagnetic materials, except for some components indicated hereinafter.

The valve system 1 may essentially comprise a valve body 10 with a working chamber 33, in which a plug 30 and an actuator element 36, acting on the latter, may be housed.

More in particular, the plug 30 and the actuator element 36 may be slidably inserted into the working chamber 33 to slide along respective longitudinal axes X and X′, mutually spaces and substantially parallel with respect to each other.

To this end, the working chamber 33 may provide for special first and second guide means for guiding the plug 30 and the actuator element 36 along respective longitudinal axes X and X′.

For example, in the embodiment of the valve system 1 of FIGS. 1A-5, the same geometry of the working chamber 33 may guide the aforementioned sliding, while in the embodiments of the valve system 1 of FIGS. 6-20B suitable guide bars or pins may be provided for.

In the embodiments illustrated herein, such valve system 1 may also include pneumatic driving means 50, which may be connected with a compressor in a per se known manner. It is also clear that in a per se known manner the driving means may be of the mechanical type instead of the pneumatic type.

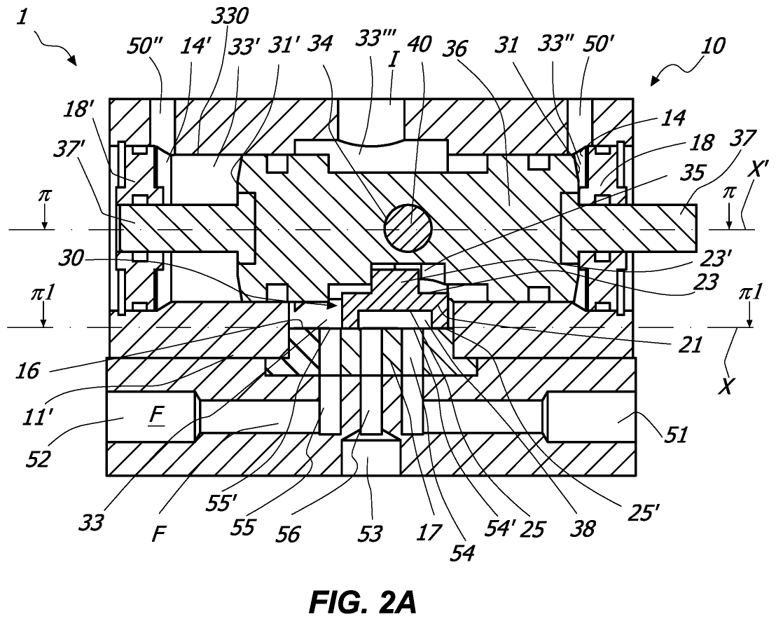

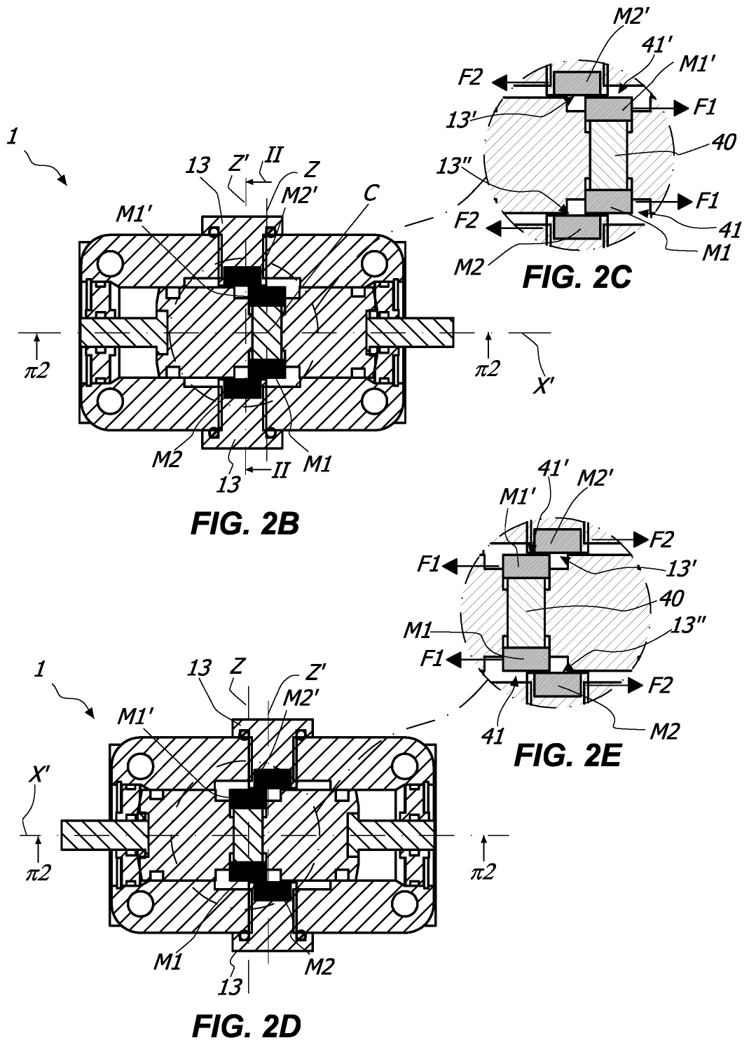

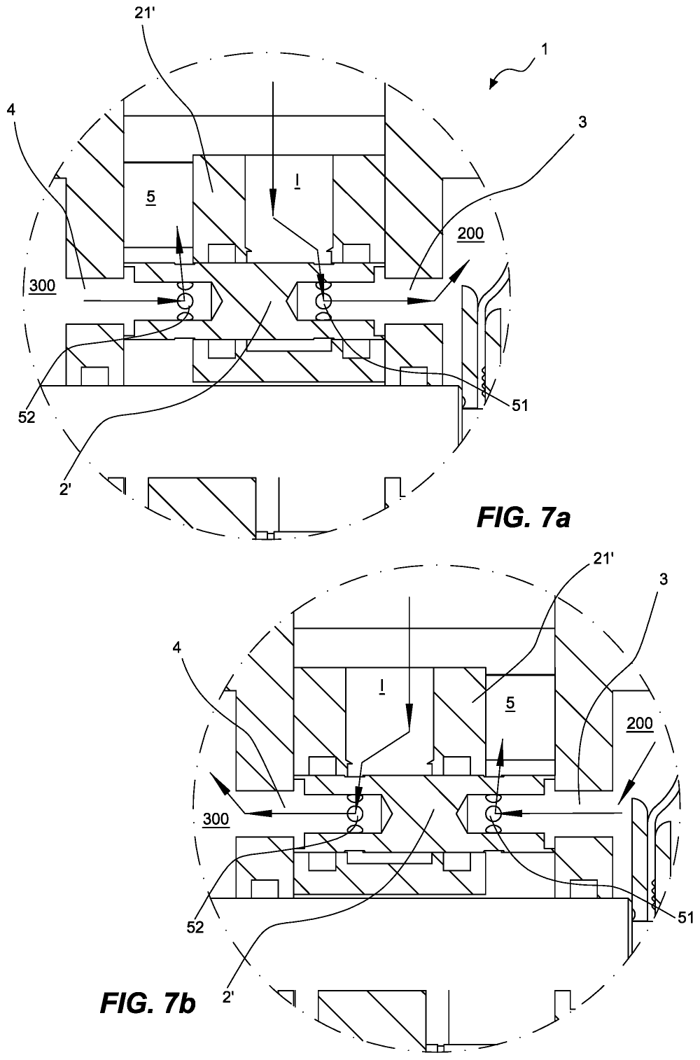

Generally, the driving means 50 may act on the actuator element 36, which may in turn act on the plug 30 to cause the displacement of the latter between a first stable working position, illustrated for example in FIGS. 2A or 7A, and a second stable working position, illustrated for example in FIGS. 2D or 7B.

As better outlined hereinafter, the mode of interaction between the driving means 50, the actuator element 36 and the plug 30 differs depending on the embodiments of the valve system 1.

More in particular, in the illustrated embodiment of the valve system 1 in FIGS. 1A-5 the driving means 50 act directly on the actuator element 36, which is in turn coupled with the plug 30 so that the movements of the latter along the axes X′ and X occur with the same directions.

On the other hand, in the illustrated embodiments of the valve system 1 in FIGS. 6-20B the driving means 50 act indirectly on the actuator element 36 by means pf suitable pins and the actuator element 36 in turn interacts with the plug 30 by means of permanent magnets M1, M1′; M2, M2′ so that the movements of the actuator element 36 and of the plug 30 along the axes X′ and X occur with different directions.

Suitably, the valve body 10 may comprise an inlet I for the working fluid and a first and a second outlet 51, 52 for the working fluid. The plug 30 will alternatingly and selectively place the inlet I in fluid communication with the first outlet 51 or with the second outlet 52.

More in particular, the plug 30 may selectively and alternatingly shut the first outlet 51 or the second outlet 52 to allow the through-flow of the working fluid respectively through the second outlet 52 or the first outlet 51.

Advantageously, in the embodiment of the valve system 1 illustrated in FIGS. 1A-5 the working fluid may be compressed air which is diverted towards the first or the second outlet 51, 52, while the pneumatic driving fluid coming from a different supply line.

On the other hand, in the embodiments of the valve system 1 illustrated in FIGS. 6-20B the working fluid may still be compressed air and it may coincide with the driving fluid, while the pumped fluid may be a liquid.

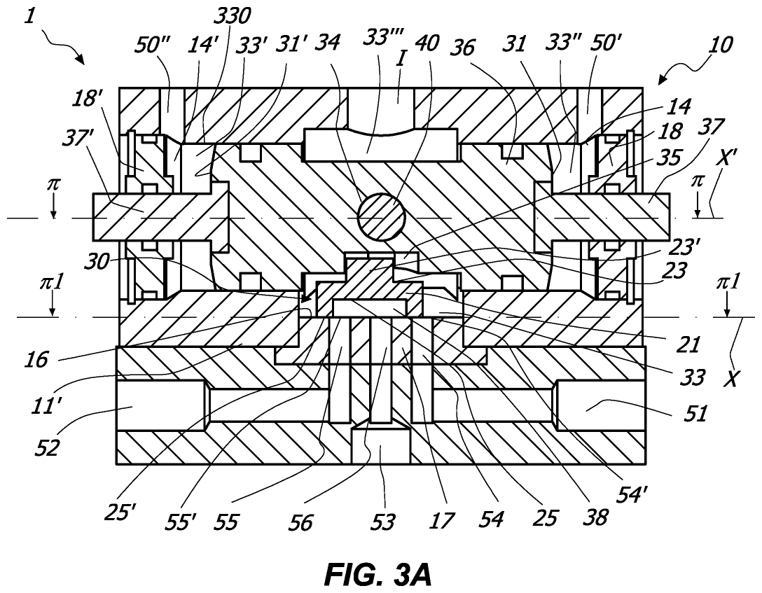

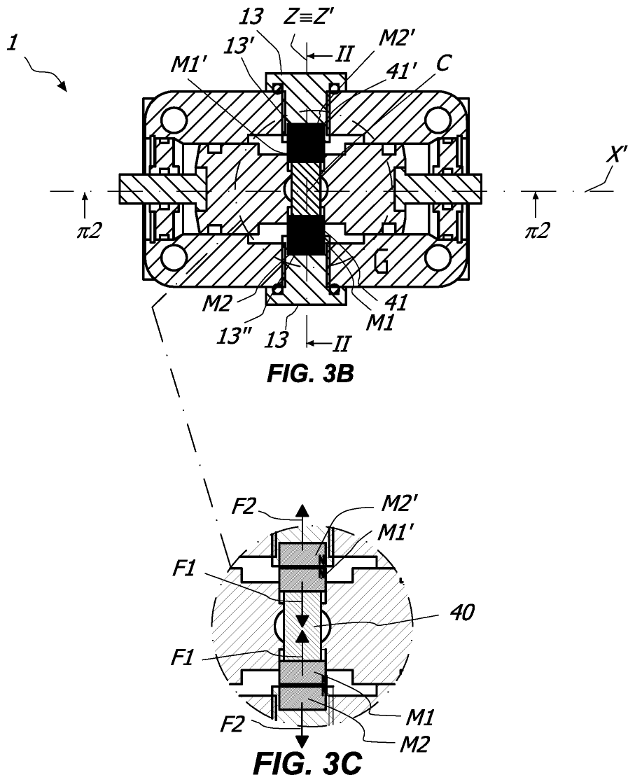

In order to overcome the stall or “dead centre” situation, there may be provided for suitable anti-stall means M1, M1′; M2, M2′ acting on the plug 30 so as to avoid the operative block of the latter in the intermediate position between the first and the second stable working position, said intermediate position being for example illustrated in FIGS. 3A or 11.

To this end, the anti-stall means may comprise a pair of first permanent magnets M1, M1′ and a pair of second permanent magnets M2, M2′, interacting with each other.

It is clear that even though hereinafter reference will be made to pairs of permanent magnets the present invention may include at least one first permanent magnet and at least one second permanent magnet without departing from the scope of protection of the attached claims.

Generally, the first permanent magnets M1, M1′ may be operatively connected with the plug 30 to slide integrally therewith along the axis X between the first and the second stable working position, while the second permanent magnets M2, M2′ may be arranged in the working chamber 33 and mutually face the first permanent magnets M1, M1′.

More in particular, as better outlined hereinafter, in the embodiment of the valve system 1 illustrated in FIGS. 1A-5 the second permanent magnets M2, M2′ may be fixed in the working chamber 33, while in the embodiments of the valve system 1 illustrated in FIGS. 6-20B the permanent magnets M2, M2′ may be coupled to the slider element 36 to slide integrally therewith along the axis X′.

The first and second permanent magnets M1, M1′; M2, M2′ may have opposite polarities. In other words, the mutually faced poles may have the same polarity.

Thus, the first and second permanent magnets M1, M1′; M2, M2′ may generate forces F1, F2 that are mutually repulsive with respect to each other, so that should the plug 30 stall, it is pushed towards one or the other of the stable working positions.

With specific reference to the embodiment of the valve system 1 illustrated in FIGS. 1A-5, the valve body 10 may consist of a cover 11 and a base 12, couplable to each other for example by means of screws V (FIG. 1A).

The cover 11 may comprise the inlet I for the working fluid F and at least one first and one second inlet 50′, 50″ for the pneumatic driving pulses.

The base 12 may include openings 54, 55 for alternatingly and selectively placing inlet I and the outlets 51, 52 positioned in the base 12 in fluid communication.

The outlet 53 connected with an external environment and the relative opening 56 (discharge) may be provided.

In a per se known manner, the outlets 51, 52 may be operatively connected with a device acting by means of alternating linear motions, for example pumps, oscillators, compressed air reciprocating motors, pistons, pneumatic hammers, vibrators, boosters.

Suitably, the outlets 51, 52 may alternatingly and selectively be delivery and discharge channels in cooperation with the outlet 53, as will be described in detail hereinafter.

More, when the working fluid flows out from the outlet 51 the plug places the outlets 53 and 52 in fluid communication to allow the discharge of the used working fluid flowing in through the outlet 52, and vice versa when the working fluid flows out from the outlet 52 the plug places the outlets 53 and 51 in fluid communication to allow the discharge of the used working fluid flowing in through the outlet 51.

Preferably, the working chamber 33 may define the axis X′ and a shuttle, which may define the actuator element 36, may be sealingly slidably inserted thereinto. More in particular, the latter may slide along the axis X′ guided by the internal surface 330 of the working chamber 33, which will define guide means for the actuator element 36.

The latter may divide the working chamber 33 into three working half-chambers 33′″, 33′, 33″ fluidically independent from each other.

The working chambers 33′, 33″ may be closed at the ends by sealing caps 18, 18′, which may include abutment surfaces 14, 14′ defining the end-stop of the actuator element 36.

Suitably, the shuttle defining the actuator element 36 may include—at the ends thereof—two pins 37, 37′, which are not represented in FIG. 5 for the sake of simplicity.

The shuttle defining the actuator element 36 may have end surfaces 31, 31′ suitable to come to mutual contact respectively with the abutment surfaces 14, 14′ during the alternating motion thereof.

The shuttle defining the actuator element 36 may also have a through hole 34 in a substantially central position into which a pin 40 arranged along an axis Z perpendicular to the axis X′ may be slidably inserted in a removable fashion. This will simplify the assembly and maintenance of the valve system 1.

Furthermore, the axis Z may be susceptible to pass through the centre C of the shuttle defining the actuator element 36. The same axis Z and the axis X may define a plane π.

Advantageously, the pin 40 may slide integrally with the shuttle defining the actuator element 36 along the same axis X′.

Suitably, the pin 40 may include the first permanent magnets M1, M1′ at the ends 41, 41′ thereof.

Advantageously, the pin 40 may be made of metal, so that the magnets M1, M1′ are naturally coupled therewith without glue or other coupling means.

As mentioned above, the second permanent magnets M2, M2′, mutually arranged adjacent to the first permanent magnets M1, M1′, may be arranged in the working chamber 33. Preferably, such second permanent magnets M2, M2′ may be arranged along an axis Z′ lying on the plane π, parallel to the axis Z and passing through the centre of the working chamber 33.

Advantageously, the magnets M1, M1′, M2, M2′ may be natural or artificial magnets, and not electromagnetic.

Preferably, the cover 11 may have a peripheral wall 15 with a pair of through holes 15′, 15″.

Furthermore, a pair of closing caps 13 each having a respective end 13′, 13″ having one of the second permanent magnets M2, M2′ may be provided for.

Advantageously, the closing caps 13 may be suitable for the removable screwing into the through holes 15′, 15″ along the axis Z′ so that the second permanent magnets M2, M2′ face the shuttle 36.

This simplifies the assembly of the valve system 1.

Advantageously, the caps 13 may be made of metal, so that the second magnets M2, M2′ are naturally coupled therewith without glue or other coupling means.

Suitably, the magnets of each pair of permanent magnets M1, M1′, M2, M2′ may be mutually symmetrical with respect to a plane π2 substantially perpendicular to the plane π1. The plane π2 may be a symmetry plane for the cover 11 so that the axis X′ lies thereon.

Furthermore, the plug 30 may advantageously be defined by a slider 21 slidable along a sliding plane π1, on which the axis X may lie.

The sliding plane π1 may comprise openings 54′, 55′ placed in fluid communication with the openings 54, 55 and with the outlets 51, 52.

It is clear that even though hereinafter reference will exclusively be made to the slider 21, the plug 30 may also comprise or consist of the latter without departing from the scope of protection of the attached claims.

The slider 21 may have a circular or rectangular shape defined by an upper surface 23 with a central portion comprising a male connection element 23′ and a lower surface 25 with a portion 25′ at mutual contact with the plane π1 so as to define a circular or rectangular working chamber 38.

The sliding plane π1 and the portion 25′ of the slider 21 will define guide means for the sliding of the latter.

Advantageously, the lower surface 25 of the slider 21 and the chamber 38 may face the openings 54, 55, 56.

Preferably, the shuttle defining the actuator element 36 may have a seat or a female connection element 35, for example circular or slot-shaped, into which the male connection element 23′ may be inserted.

As particularly illustrated in FIGS. 2A and 5, the connection element 23′ of the slider 21 will take a determined position from the position of the slot 35 obtained in the shuttle defining the actuator element 36.

Suitably, the slider 21 may be susceptible to move in the working chamber 33 along the plane π1 on which the axis X lies substantially parallel to the plane π on which the axis X′ lies and spaced by the anti-stall means M1, M1′, M2, M2′.

Suitably, the cover 11 may comprise a lower wall 11′ susceptible to face the base 12. p In addition, the lower wall 11′ may comprise a through hole 16, into which a closing element 17 may be inserted to remain interposed between the base 12 and the cover 11.

The closing element 17 may comprise a lapping surface defining the sliding plane π1 and the openings 54, 55, 56 for placing the three outlets 51, 52, 53 and the working chamber 33 in fluid communication.

Operatively, as illustrated in FIGS. 2A-2E, when the shuttle defining the actuator element 36 for example receives a driving pulse from the inlet 50″, the end surface 31 thereof will be mutually at contact with the abutment surface 14 of the sealing cap 18. The working fluid F, which flows in through the inlet I, will fill the working chamber 33 and it will be ejected through the opening 55 and the outlet 52. Thus, the inlet I of the valve body 10 will be in fluid communication with the second outlet 52 so as to allow the outflow of the working fluid F.

Simultaneously, the discharge of the used working fluid F coming from the user device sequentially through the outlet 51, the opening 54, the chamber 38, the opening 56 and the outlet 53 will be allowed.

Vice versa, the operation will be mirror-like when the shuttle defining the actuator element 36 will receive a driving pulse from the inlet 50′ so that the end surface 31′ of the shuttle defining the actuator element 36 is at mutual contact with the abutment surface 14′ of the sealing cap 18′.

The working fluid F will fill the working chamber 33 and it will be ejected through the opening 54 and the outlet 51. Thus, the inlet I of the valve body 10 will be in fluid communication with the first outlet 51 thereof to allow the outflow of the working fluid F.

Simultaneously, the discharge of the working fluid F coming from the user device sequentially through the outlet 52, the opening 55, the chamber 38, the opening 56 and the outlet 53 will be allowed.

Suitably, the first pair of magnets M1, M1′ will generate a pair of forces F1 of equal module and direction opposite to the pair F2 generated by the second pair of magnets M2, M2′.

Advantageously, the forces F1 and F2 will be generated on the plane π parallel to the sliding plane π1 of the slider 21 or other known valve systems.

This will allow providing different known types of valve systems, for example of the slider type, as described herein, of the sleeve type or of the plug type, in which the plane π and π1 can be kept distinct. Thus, there will be obtained a magnetic unbalancing system suitable to overcome the so-called ‘dead centre’ situation defined by an operative block position.

Given that the forces F1 and F2 are mutually repulsive with respect to each other, the latter will keep the translation of the shuttle defining the actuator element 36 quick and controlled.

The valve system 1 illustrated in FIGS. 1A to 5 will have the same operation choosing an actuation of the mechanical type operated by external forces alternatingly acting along the axis X, for example on the pins 37, 37′.

In such case, the driving inlets 50′, 50″ will serve as discharge for the air volume respectively and alternatingly accumulated in the chambers 33″, 33′ by the alternating motion of the shuttle defining the actuator element 36.

With reference to the embodiments illustrated in FIGS. 6-20B, illustrated are pumps P1, P2 of the double membrane type, in particular in FIGS. 6 to 19, or a pump P3 of the double piston type, in particular in FIGS. 20A and 20B.

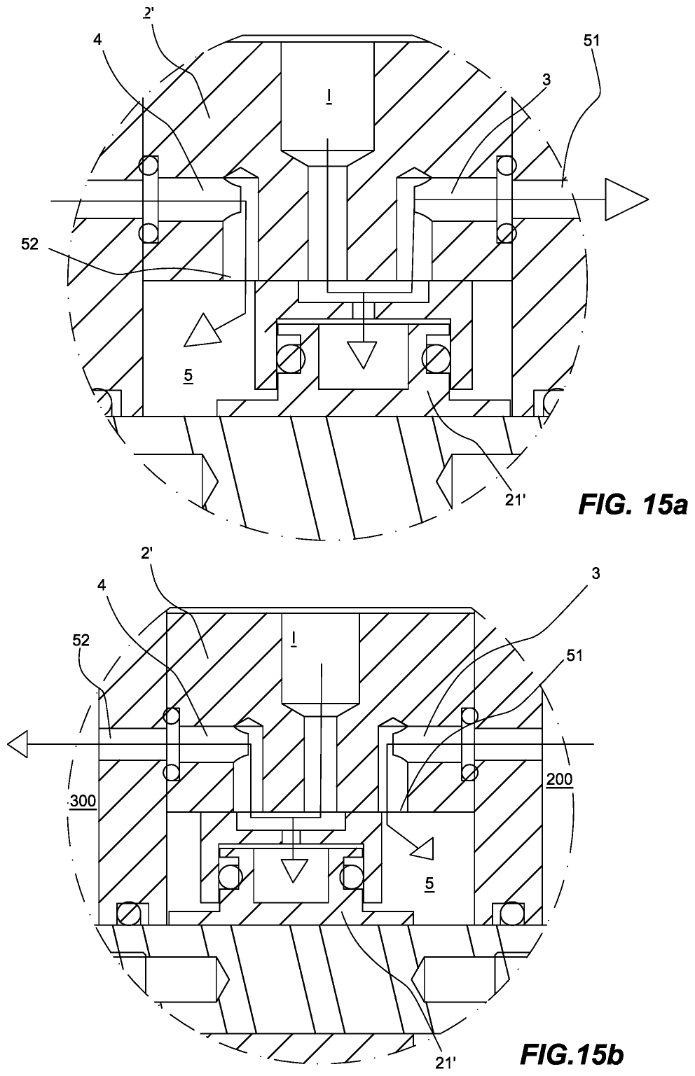

It is clear that the operation of the pumps P1, P2 and P3 is substantially identical, both as concerns the double membrane pump and the double piston pump. Thus, in the description hereinafter, reference will be made to the membrane pump P1 illustrated in FIGS. 6 to 13, it being deemed that the description also applies to the membrane pump P2 illustrated in FIGS. 15-19 and the double piston pump P3 illustrated in FIGS. 20A-20B.

The pump P1 may include a support structure 2 with a first half-chamber 200 which includes a first membrane 210, and a second half-chamber 300 which includes a second membrane 310.

In a per se known manner, the support structure 2 of the pump P1 may also comprise a third and a fourth half-chamber 400, 500 suitable to house the pumped fluid, in a per se known manner. Furthermore, such third and fourth half-chamber 400, 500 will be connected to an intake circuit S and a delivery circuit D.

The first and the second membrane 210, 310 may be mechanically connected to each other. For example, in the embodiment shown in FIG. 1a, the two membranes 210, 310 may be connected through an extended rod 600.

In the embodiments of the valve system 1 illustrated in FIGS. 6 to 20B, the valve body 10 may be interposed between the half-chambers 200, 300 to alternatingly and selectively convey to the latter the working fluid coming from a compressor for example.

To this end, a fixed air distributor 2′ which will fluidically connect the valve body 10 and the half-chambers 200, 300 through selective interaction with the plug 30 may be provided for.

The valve body 10 may include the working chamber 33, which may in turn include the plug 30 and the actuator element 36.

More in particular, the plug 30 may comprise a first slider element 21′ with sleeve slidable along the fixed air distributor 2′, which will define the axis X between the first and the second stable working position, illustrated for example in FIGS. 7A and 7B.

Thus, the slider element 21′ with sleeve will alternatingly and selectively place the inlet I of the working chamber 33 in communication with the first or the second half-chamber 200, 300 through the outlets 51, 52.

Thus, when the half-chamber will increase the volume due to the working fluid flowing thereinto, the volume of the other half-chamber will reduce, emptying. The fluid discharged by the emptying half-chamber will end up in a fifth half-chamber 5 connected with the external environment and interposed between the first and the second half-chamber 200, 300.

In order to allow such operation, the fixed air distributor 2′ may include a first duct 3 for placing the working chamber 10 and the first half-chamber 200 in fluid communication and a second duct 4 for placing the working chamber 10 and the second half-chamber 300 in fluid communication.

The actuator element 36 may comprise a second slider element 83 with respective guide bars or pins 81, 81′, which may define the axis X′. Simultaneously, the guide bars or pins 81, 81′ may selectively come into contact with the respective first or second membrane 210, 310 to define pushing means, as illustrated hereinafter.

Given that the two membranes 210, 310 are connected, as shown in FIG. 6, the displacement of the first membrane 210, due to the increase of the volume thereof, corresponds to the displacement of a second membrane 310 in the same direction.

The second membrane 310 may come into contact with the guide pin or bar 81 for actuating the displacement of the slider element 21′, which will slide along the axis X guided not only by the fixed air distributor 2′ but also by the guide bars 72, 72′ inserted into respective through seats 77, 77′.

The second slider element 83 of the actuator element 36 may be slidably guided along the axis X′ not only by the pins 81, 81′ but also by the guide bars 84, 84′ inserted into respective through seats 88, 88′.

The second slider element 83 may be arranged substantially facing the first slider element 21′.

Suitably, the first and the second slider element 21′, 83 may respectively include the first natural permanent magnets M1, M1′ and the second natural permanent magnets M2, M2′, of the same polarity and facing each other.

In a preferred but non-exclusive embodiment, the magnets M1, M1′; M2, M2′ may be arranged on the first and second slider element 21′, 83 at respective end portions designated to be arranged facing each other when the magnets M1, M1′; M2, M2′ are in mutual correspondence during their mutual sliding along the axes X, X′, for example as illustrated in FIG. 11.

Thus, the magnets M1, M1′; M2, M2′ will advantageously generate the repulsive forces F1, F2, as outlined above.

The sliding constraint of the first slider element 21′ and of the second slider element 83 on the respective guide bars 72, 72′; 84, 84′ will allow to eliminate the normal component of the repulsive magnetic force, which will develop solely along the axes X, X′ with high intensity, increasing as the magnets M1, M1′; M2, M2′ approach.

This fully solves the problem relating to the so-called “dead centre”, in particular at low speeds or low working pressure.

From a construction point of view, the pump 1 consists of a minimum number of pieces. As a matter of fact, the support structure of the pump 1 may consist of two end covers 90, 91 and a central element which includes the valve system 1.

The end cover 90 may include the first half-chamber 200, the third half-chamber 400 and the first membrane 210, while the end cover 910 may respectively include the second half-chamber 300, the fourth half-chamber 500 and the second membrane 310.

In light of the above, it is clear that the invention attains the pre-set objectives.

The invention is susceptible to numerous modifications and variants all falling within the inventive concept outlined in the attached claims. Furthermore, all details can be replaced by other technically equivalent elements, and the materials can be different depending on the needs, without departing from the scope of protection defined by the attached claims.

1.-24. (canceled)

25. A bistable valve system, comprising:
a valve body comprising an inlet for a working fluid and a first and a second outlet for the working, said valve body including a working chamber defining a first longitudinal axis;
a plug slidingly inserted into said working chamber to slide along the first longitudinal axis between a first stable working position and a second stable working position so as to alternatingly and selectively place said inlet and said first outlet or said second outlet in communication;
a pneumatic or mechanical driving system acting on said plug to drive a sliding thereof between said first and said second stable working positions;
an actuator operatively connected to said pneumatic or mechanical driving system and to said plug to cause the sliding of the plug between said first and said second stable working positions, said actuator being slidably inserted into said working chamber to slide along a second longitudinal axis parallel to said first longitudinal axis; and
an anti-stall system acting on said plug,
wherein said anti-stall system comprises a first permanent magnet operatively connected to said plug to integrally slide therewith between said first and said second stable working positions, said anti-stall system further comprising a second permanent magnet arranged in said working chamber and facing said first permanent magnet, said first and said second permanent magnet having opposite polarities to generate forces repulsive to each other, so as to prevent an operative block of the plug in an intermediate position between said first and said second stable working positions, and
wherein said actuator comprises said first permanent magnet, said plug and said actuator being mutually coupled to slide respectively along the first and the second longitudinal axis in a same direction, said second permanent magnet being fixed in said working chamber.

26. The bistable valve system according to claim 25, wherein said plug is adapted to selectively and alternatingly shut said first outlet or said second outlet to allow a flow-through of the working fluid through second outlet or respectively said first outlet.

27. The bistable valve system according to claim 25, wherein said first and longitudinal second axes are mutually spaced.

28. The bistable valve system according to claim 25, wherein said valve body comprises a first guide for slidably guiding said plug along said first longitudinal axis and a second guide for slidably guiding said actuator along said second longitudinal axis.

29. The bistable valve system according to claim 25, wherein said working chamber has an inner surface facing said actuator, said second permanent magnet being fixed to said inner surface.

30. The bistable valve system according to claim 25, wherein said first permanent magnet and said second permanent magnet are arranged at said second longitudinal axis.

31. The bistable valve system according to claim 25, wherein said plug comprises a slider slidable in said working chamber along a first sliding plane which comprises openings placed in fluid communication with said first and said second outlet, said first longitudinal axis lying on said first sliding plane, said second longitudinal axis being mutually spaced from said first sliding plane.

32. The bistable valve system according to claim 31, wherein said first permanent magnet and said second permanent magnet lie on a second plane passing through said first longitudinal axis and parallel to said first plane.

33. The bistable valve system according to claim 31, wherein said anti-stall system comprises a pair of first permanent magnets and a pair of second permanent magnets, said first permanent magnets being coupled to said actuator, said second permanent magnets being arranged in said working chamber symmetrically with respect to a symmetry plane perpendicular to said first plane and passing through said first longitudinal axis.

34. The bistable valve system according to claim 33, wherein said first and second permanent magnets respectively lie along a second and a third axes perpendicular to said first longitudinal axis and parallel to each other, said second and third axes intersecting said first longitudinal axis.

35. The bistable valve system according to claim 33, wherein said valve body has at least one peripheral wall which includes at least one first through hole, there being provided at least one closing cap having an end which includes said second permanent magnet, said at least one closing cap being removably insertable into said at least one first through hole so that said second permanent magnet faces said first permanent magnet.

36. The bistable valve system according to claim 35, wherein said at least one peripheral wall has at least one pair of first through holes mutually opposite with respect to said symmetry plane, there being provided for at least one pair of closing caps each having a respective end which includes one of said second permanent magnets, said closing caps being removably insertable into said first through holes so that said second permanent magnets face said plug.

37. The bistable valve system according to claim 33, wherein said actuator has a second through hole, there being provided a pin having a pair of opposite ends, at least one of said opposite ends comprising said first permanent magnet, said pin being removably and slidably insertable into said second through hole so that said first permanent magnet faces said second permanent magnet.

38. The bistable valve system according to claim 37, wherein said anti-stall system comprises a pair of first permanent magnets and a pair of second permanent magnets, and wherein each of said opposite ends of said pin includes a respective first permanent magnet, the respective first permanent magnet lying on opposite sides with respect to said symmetry plane so as to face said second permanent magnets.

39. The bistable valve system according to claim 37, wherein said second through hole is obtained in a central position with respect to said actuator, one of said slider (21) and said actuator comprising a male connection element, the other one of said slider and said actuator comprising a female connection element, the one of said male or female connection element belonging to said actuator being arranged at said second through hole.
